(19) United States
(12) Patent Application Publication
(10) Pub. No.: US 2023/0222477 A1
(43) Pub. Date: Jul. 13, 2023

(54) PROXIMAL PEER TO PEER MONEY TRANSFER

(71) Applicant: Peter Garrett, Aromas, CA (US)

(72) Inventor: Peter Garrett, Aromas, CA (US)

(21) Appl. No.: 17/725,611

(22) Filed: Apr. 21, 2022

Related U.S. Application Data
(63) Continuation of application No. 16/132,450, filed on Sep. 16, 2018, now abandoned.
(60) Provisional application No. 62/559,505, filed on Sep. 16, 2017.

(51) Int. Cl. G06Q 20/22; G06Q 20/32; G06Q 20/38; G06Q 20/34

(52) U.S. Cl. CPC G06Q 20/223; G06Q 20/327; G06Q 20/3825; G06Q 20/352; G06Q 2220/00

(57) ABSTRACT

The invention teaches an innovative way for users to transfer funds or crypto currency using proximal peer to peer funds transfer methodology wherein one user with a dynamic IOT smart device enabled with a proximal peer to peer funds transfer software can to transfer funds based on proximity to another user with a dynamic IOT smart device enabled with a proximal peer to peer funds transfer software. These funds transferred from one dynamic IOT smart device enabled with a proximal peer to peer funds transfer software to another may be encrypted and processed through the internet/payment gateway or may be encrypted within the proximal peer to peer funds transfer software to be processed at a later time when an alternate connection to the internet/payment gateway may be established.

### CROSS-REFERENCE TO RELATED APPLICATIONS

This US non-provisional patent application is a continuation of U.S. patent application Ser. No. 16/132,450, filed Sep. 16, 2018, which claims priority to U.S. Provisional Application Ser. No. 62/559,505, filed Sep. 16, 2017, which are hereby incorporated herein by reference.

### BACKGROUND OF THE INVENTION

### 1. Field of the Invention

The invention is in the area of are of wireless funds transfer between smart cards and smart IOT devices and more particularly to proximal funds transfer between wireless peer to peer IOT devices.

### 2. Discussion of the State of the Art

Mobile transactions have recently been on the rise. Millennial people and younger people are not use to the legacy financial systems in place for the last 20 plus years. Going to banks and writing checks are not their style. This group of people and older folks are looking for a simpler way to transfer monies to each other. What is clearly needed is a proximal peer to peer money transfer system whereby users can transfer money wirelessly from IOT devices such as smart cards and or other smart devices.

### SUMMARY OF THE INVENTION

A method for wireless proximal transfer of funds from a first user to a second user is taught comprising, in one embodiment a first and a second dynamic IOT (internet of things) smart device comprising a NFC transceiver capability, a BLE transceiver capability, a wireless capability, an MST capability, an inductive charging capability, a battery, a host MCU, a touch screen, a biometric authentication capability, a secure element and tokenization capability and a wireless proximal peer to peer software application wherein a first dynamic IOT smart device of a first user sends a wireless pair request to a second user with a second dynamic IOT smart device through a wireless proximal peer to peer software application resident on the first dynamic IOT smart device and the second dynamic IOT smart device and wherein a second user accepts the pair request from the first user who desires to transfer funds to a second user via a wireless proximal peer to peer software application and wherein the funds amount and necessary financial account information of the first user are tokenized by the first dynamic IOT smart device sent to the cloud and further through a payment gateway wherein the token is decrypted, authenticated, tokenized and sent back through the gateway through the cloud and to the second IOT smart device were the funds would be deposited.

In one embodiment dynamic IOT smart devices are not enabled with Wi-Fi wherein the need for a preloaded account on the dynamic IOT smart devices would not be necessary for users to send money to each other and wherein tokenization could take place to secure/encrypt the transaction through a direct proximal peer to peer wireless connection, using the secure elements within the MCU within the dynamic IOT smart devices to generate the tokens wherein tokens would then be stored in the proximal peer to peer software application until a alternate internet connection became available to the dynamic IOT smart devices wherein the proximal peer to peer software applications once alternate internet connections became available turn the tokenized currency back into cash to be deposited into the user's bank account, credit card or other monetary holding device and wherein the process of course works visa versa where funds may be moved from a bank account to a dynamic IOT smart device and then to a second dynamic IOT smart device through a proximal peer to peer software application. In one embodiment a user that receives funds on his IOT smart device may send funds to the bank of his choice or leave funds secured in the wireless proximal peer to peer software application.

In one embodiment both IOT smart devices are smart cards

In another embodiment both IOT smart devices are smartphones

IN one embodiment one IOT smart device is a smartcard and one IOT smart device is a smart phone.

In another embodiment in the funds transfer method of the invention the funds transferred is a currency such as crypto currency.

### BRIEF DESCRIPTION OF THE DRAWING FIGURES

FIG. 1 is an illustration of proximal money transfer between 2 dynamic Smartcards.

FIG. 2 is an illustration of proximal money transfer between a dynamic Smartcard and a Smartphone or IOT device.

FIG. 3 is an illustration showing proximal money transfer between 1 smartphone or IOT device and 1 dynamic smartcard.

FIG. 3A is an example of a tokenization scheme and secure elements scheme and can be applied to the embodiments concerning tokenization and secure elements in the drawings where these embodiments are mentioned.

FIG. 3B is a block diagram showing how secure elements and datasets may be managed

### DETAILED DESCRIPTION OF THE INVENTION

The present invention provides a proximal money, currency or crypto currency transfer between 2 dynamic smartcards, 2 smartphones or IOT devices or one dynamic smartcard and one smartphone or IOT device.

The wireless technology utilized to perform these proximal transfers may be Bluetooth, NFC, RFID or Wi-Fi. Any other wireless technology may be adapted to be utilized as well.

Both the dynamic smartcards and smartphones or any IOT devices may be equipped with a proximal peer to peer software application and the necessary hardware and circuitry to run said software application. In this specification dynamic IOT smart device can refer to a dynamic smart card, a dynamic smartphone or any other IOT smart device such as a smart payment ring or a smart payment watch or any other internet connected smart device capable of housing the necessary software, hardware, circuitry etc . . . to make a proximal funds transfer.

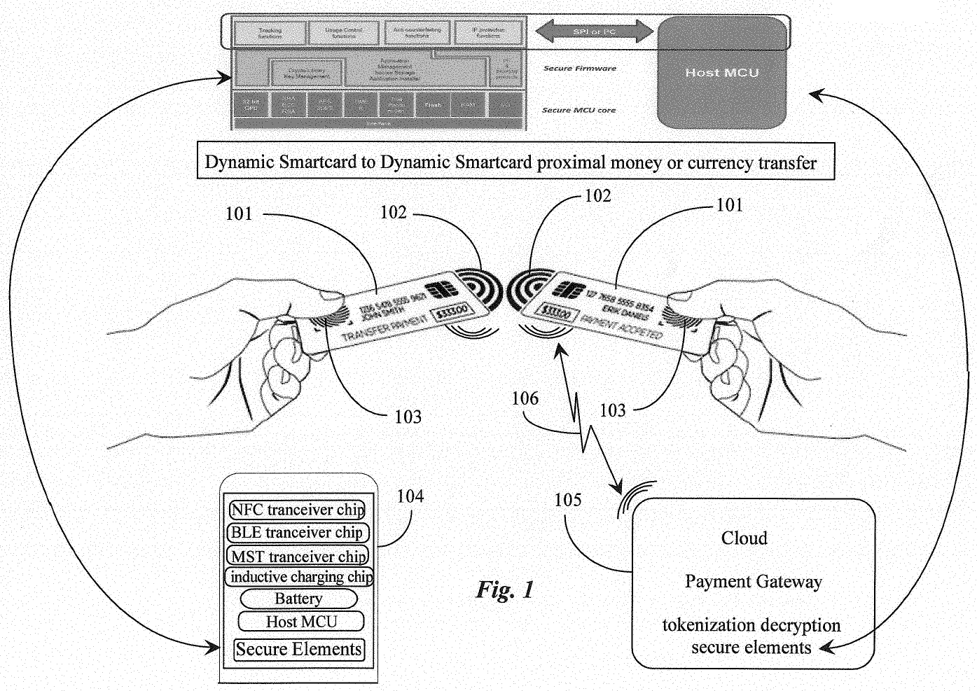

FIG. 1 is an illustration of proximal money transfer between 2 dynamic Smartcards 101. In this embodiment a biometric authorization 103 through a fingerprint sensor is used to authenticate the user and his accounts. Both dynamic smartcards 101 may be linked by wireless pairing 102 which can always be discoverable or be always discoverable. A user has the ability to accept or deny any pairing event from any other IOT device or dynamic smartcard.

The smartcard 101 of FIG. 1 is enabled with a screen, a touch screen, an MCU, secure elements, rechargeable battery (inductive charging capability as well), wireless chips, circuitry, antennas, biometric sensors, an accelerometer and GPS (indicated by element 104) to enable necessary hardware functions. Where ever chip is indicated in element 104 the necessary circuitry is also assumed enabling the capability mentioned in element 104

In one embodiment the dynamic smartcards 101 of FIG. 1 may be in very close proximity or touch to initiate a currency transfer as in tap and pay. In another embodiment tap to pay is used with card to smartphone, and smartphone to smartphone. In another embodiment a nearby wave of a device will be sufficient to initiate proximal transfers.

In one embodiment, that the Dynamic Smartcards of FIG. 1 could use secure elements i.e. tokenization to encrypt currencies and funds. In this embodiment the Dynamic Smartcard may have a Wi-Fi connection it may send the transfer through a payment gateway in the cloud and then decrypt at the card issuer or network (Visa, MasterCard, Etc.) This would be like using Google Wallet, Square Cash, Venmo, etc with tokenization.

In another embodiment the Dynamic smartcards are not enabled with Wi-Fi so there would be no need for a preloaded account on the Dynamic Smartcard that the user would use to send money. Again, tokenization could take place to secure/encrypt the transaction but rather than calling out to the cloud through a payment gateway it would be through a direct proximal peer to peer wireless connection, using the secure elements within the MCU element 104 to generate the tokens. These tokens would then be stored in the software app until a connection became available and the software application turned the tokenized currency back into cash to be deposited into the user's bank account, credit card or other monetary holding device. This process of course works visa versa where funds need to move from a bank account to a dynamic card and then to another dynamic card with proximal funds transfer.

The user would then bump (wirelessly) the data (encrypted tokenized data) to their phone to turn it into cash via Wi-Fi connection to the user's bank account which is linked to their proximal peer to peer software application. Once the bank or credit issuer decrypts the encrypted tokenized data, cash is past back to the user's application on their Smartphone which in turn bumps to the user's paired Dynamic Smartcard as tokenized currency.

Biometrics may be utilized every time a transaction occurs but may not be needed in one embodiment if the users have previously interacted in this way before and they have each other's secure elements stored in their respective devices. In another embodiment the currency may be translated into any currency in the world or any crypto currency in the world with appropriate exchange rates stored in the software application or secure elements which would be updated as cloud/internet connection became available.

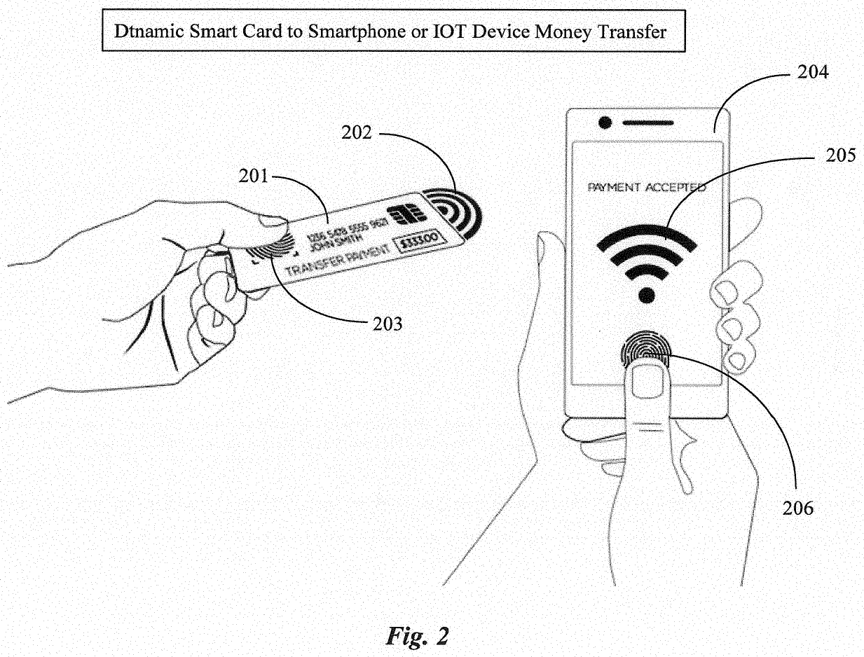

FIG. 2 depicts a transaction being initiated between a smartcard 101 and a smart phone 204. Smart card is capable of FPS biometrics 203, contains a touch screen secure element technology and the name and account holder as well as antenna and wireless capability 202. Smartphone 204 also contains FPS biometric capability 206, wireless capability 205. Smart phone as stated previously contains all of the capability of the devices spoken of in FIG. 1

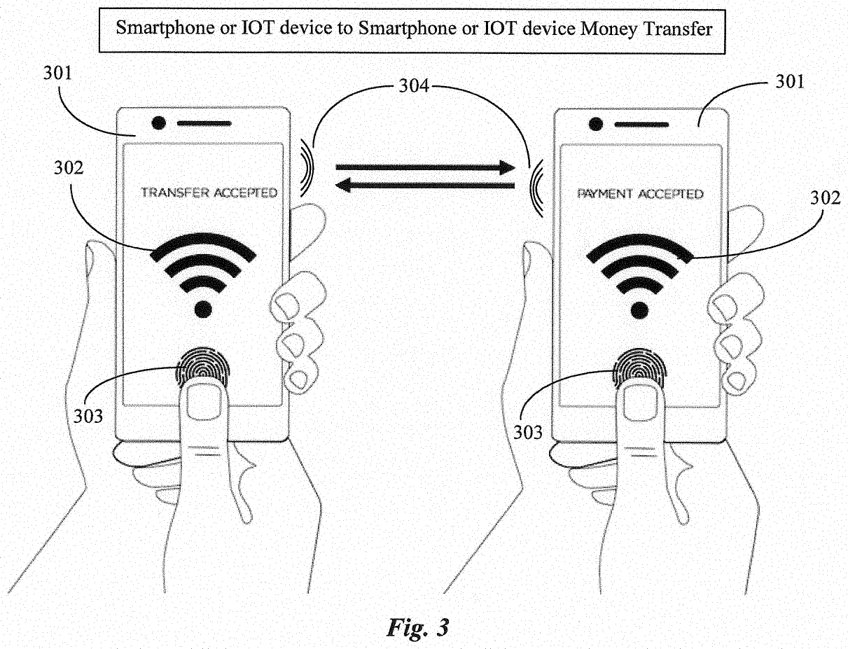

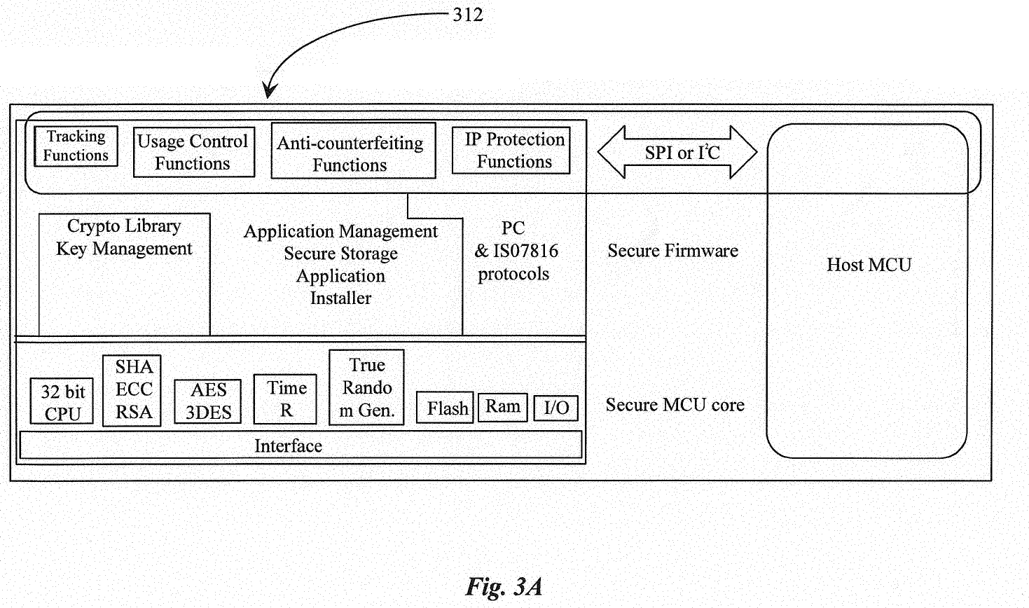

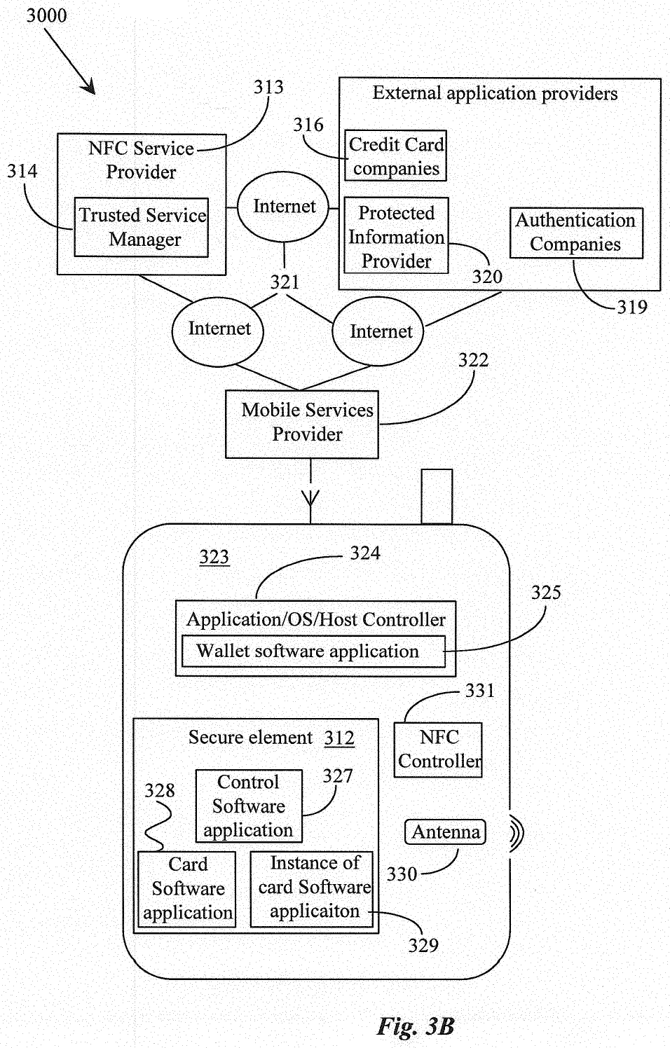

FIG. 3 is an example of a proximal funds transfer transaction between 2 smart phones 301. There are connected through NFC 304 in this embodiment but could use other wireless protocols. Both smartphones 301 are equipped with FPS biometric capability 303. Both smartphones are also showing on touch screen that a transaction is in process.

FIG. 3A is an example of a secure element capability 312 which is part of the capability of devices such as dynamic IOT devices like dynamic smart cards and dynamic smart cards

FIG. 3B depicts a block diagram illustrating systems 3000 for controlling multiple secure element based card software applications using a secure element based control software application according to certain exemplary embodiments of the present invention. In one embodiment an external trusted service manager (TSM) 314 controlled by a near field communications (NFC) service provider 313 hosts and transmits card software applications for installation within the secure element 312 residing on dynamic devices of dynamic smart cards and dynamic smart cards of the invention. The NFC service provider 313 provides a secure key encrypted software card application for decryption and installation in the secure element 312. The TSM 314 includes a trusted service agent, which may be automated software.

Contactless payment technology incorporates proximity communications between two devices to authenticate and enable payment for goods and services over the air (OTA) or without physical connection. Near Field Communication (NFC) is an example of a proximity communication option that can enable contactless payment technologies and that is supported by the Global System for Mobile Communications (GSM) Association. RFID is an example of a proximity communication method that can be adapted to enable NFC contactless payment technology. NFC communication ranges generally range from about 3 to about 4 inches. Such short communication distances limit, as well as, enable secure communication between closely held proximity enabled devices.

An NFC-enabled contactless payment device such as module Dynamic Smartcards as in FIG. 1 enable financial transactions, secure authentication, protected information provider 320 authentication companies 319 among several services that are available to the device owner. Where in the later case Dynamic Smartcard communicates via wireless to a smartphone which can be used to secure bank information from an authenticating server called a trusted service manager (TSM) 314. The bank information is used authenticate currency transfers between devices shown in FIGS. 1 and 2. The TSM hosts and controls all credit card information sent to or withdrawn from a trusted NFC enabled contactless payment device such as Dynamic smartcards and smartphones of FIG. 1.

In one embodiment of the invention a software application for credit card secure element information acquisition and implementation for handling multiple credit card secure element information sets is disclosed. A dynamic smartcard software application can be identified by Application Identifiers (AIDs) and are typically stored within the secure element 312 of the Dynamic smartcards and or IOT devices of FIGS. 1 and 2. The secure element 312 can exist within a dynamic smartcard, or an IOT device such as a smartphone. The secure element 312 allows a Proximal Peer to Peer Software App to reside and be accessible by the dynamic smartcard, smartphone or IOT device user to interact securely with certain functions within the secure element, while protecting a majority of the information stored within it. Secure element 312 on dynamic smartcards, smartphones and other IOT devices function as a secure communication channel and use encryption methods for communication between the secure element 312 and dynamic smartcards, smartphones and other IOT devices to which it is attached. The secure element 312 on the dynamic smartcards, smartphones and other IOT devices includes crypto processors for calculating crypto algorithms for crypto currencies via protected information provider 320.

What is claimed is:

1. A method for wireless proximal transfer of funds from a first user to a second user comprising:
A first and a second dynamic IOT (internet of things) smart device comprising a NFC transceiver capability, a BLE transceiver capability, a wireless capability, an MST capability, an inductive charging capability, a battery, a host MCU, a touch screen, a biometric authentication capability, a secure element and tokenization capability and a wireless proximal peer to peer software application wherein a first dynamic IOT smart device of a first user sends a wireless pair request to a second user with a second dynamic IOT smart device through a wireless proximal peer to peer software application resident on the first dynamic IOT smart device and the second dynamic IOT smart device and wherein a second user accepts the pair request from the first user who desires to transfer funds to a second user via a wireless proximal peer to peer software application and wherein the funds amount and necessary financial account information of the first user are tokenized by the first dynamic IOT smart device sent to the cloud and further through a payment gateway wherein the token is decrypted, authenticated, tokenized and sent back through the gateway through the cloud and to the second IOT smart device were the funds would be deposited.

2. The method of claim one wherein dynamic IOT smart devices are not enabled with Wi-Fi wherein the need for a preloaded account on the dynamic IOT smart devices would not be necessary for users to send money to each other and wherein tokenization could take place to secure/encrypt the transaction through a direct proximal peer to peer wireless connection, using the secure elements within the MCU within the dynamic IOT smart devices to generate the tokens wherein tokens would then be stored in the proximal peer to peer software application until a alternate internet connection became available to the dynamic IOT smart devices wherein the proximal peer to peer software applications, alternate internet connections became available turned the tokenized currency back into cash to be deposited into the user's bank account, credit card or other monetary holding device and wherein the process of course works visa versa where funds may be moved from a bank account to a dynamic IOT smart device and then to a second dynamic IOT smart device through a proximal peer to peer software application.

3. The method of claim one wherein a user that receives funds on his IOT smart device may send funds to the bank of his choice or leave funds secured in the wireless proximal peer to peer software application.

4. The method of claim one wherein both IOT smart devices are smart cards

5. The method of claim one wherein both IOT smart devices are smartphones

6. The method of claim one wherein one IOT smart device is a smartcard and one IOT smart device is a smart phone.

7. The method of claim 1 wherein the funds transferred is a currency such as crypto currency.
